(19) United States
(12) Patent Application Publication
(10) Pub. No.: US 2018/0234153 A1
(43) Pub. Date: Aug. 16, 2018

(54) Low-Power Channel-State-Information Reporting Mode

(71) Applicant: Telefonaktiebolaget LM Ericsson (publ), Stockholm (SE)

(72) Inventors: Bo Lincoln, Lund (SE); Robert Baldemair, Solna (SE); Martin Hessler, Linköping (SE); Eleftherios Karipidis, Stockholm (SE); Torgny Palenius, Barsebäck (SE); Eliane Semaan, Sundbyberg (SE)

(21) Appl. No.: 15/549,498

(22) PCT Filed: May 11, 2017
(86) PCT No.: PCT/SE2017/050475

§ 371 Date: Aug. 8, 2017

Related U.S. Application Data
(63) Continuation-in-part of application No. 15/154,403, filed on May 13, 2016.

(51) Int. Cl. H04B 7/06; H04W 24/10; H04W 52/02; H04J 11/00

(52) U.S. Cl. CPC H04B 7/0626; H04W 24/10; H04B 7/0695; H04J 11/0079; H04B 7/0617; H04W 52/0274

(57) ABSTRACT

Techniques disclosed herein include a method carried out by a wireless device (1000) operating in a wireless communications network, where the method includes determining (710) a reporting quality threshold for a parameter related to channel state information, CSI, and performing (720) a measurement for each of a plurality of beams from a first predetermined set of beams for evaluation. The method further includes evaluating (730) the measurement for each of the plurality of beams against the reporting quality threshold, and discontinuing (740) the performing and evaluating of measurements in response to determining that the reporting quality threshold is met for one of the beams, such that measurements are not performed and evaluated for one or more beams in the first predetermined set of beams. The method further includes reporting (750) the CSI for the one of the beams to the wireless communications network.

### TECHNICAL FIELD

The present disclosure is generally related to wireless communications networks, and is more particularly related to measurements performed by wireless devices to determine channel-state information in such networks.

### BACKGROUND

Members of the 3rd-Generation Partnership Project (3GPP) are developing standards for the so-called fifth generation (5G) cellular wireless networks, which are envisioned to overcome the limitations of existing cellular networks by allowing for higher data rates, improved user experience, lower energy consumption, while providing capacity improvements to satisfy the ever-increasing traffic demand. To serve these purposes, there is a need for additional spectrum beyond what was previously allocated to existing standards. The use of high-frequency bands, including licensed, unlicensed and licensed-shared spectrum, is a potential candidate to overcome the problem of scarce spectrum resources by allowing for wider bandwidths and the deployment of more advanced antenna arrays and massive beam-forming.

For the evolving wireless communication systems to handle the envisioned growth in traffic volume, wider frequency bands, new spectrum, advanced antenna solutions, and, in some cases, denser deployments, are needed. In addition, a massive growth in the number of connected devices as well as an increasingly wide range of new applications are expected, to enable a well-functioning networked society where information can be accessed and data shared anywhere and anytime, by anyone and anything, At the same time, other still-evolving technologies, including the fourth generation (4G) cellular wireless networks and Wi-Fi, are challenged by the same demands.

Multi-antenna technologies have a key role in the design of modern radio access technologies (RATs) due to their well-recognized benefits. Specifically, they enable array gain, spatial multiplexing, and spatial diversity, which lead to improved coverage, capacity, and robustness. Multi-antenna features have significantly contributed to the success of LTE and continue driving its evolution.

Multi-antenna technologies have an even higher relevance in high frequency bands. For instance, high-frequency propagation is subject to several loss factors, starting with high atmospheric attenuation, rain fade, foliage attenuation, building and wall penetration, diffraction and body/obstruction loss. While some of these loss aspects may be considered as minor problems for lower frequency bands, their impact becomes severe in millimeter wave ranges. While the increased path loss arising from these aspects limits potential communications range, high frequency bands allow for smaller frequency reuse distances, larger bandwidth and small beam width allowing for higher gain values, which in turn can compensate to some extent for the experienced higher path loss. Hence, these factors and restrictions pose several design challenges on the evolving RATs but also provide solution opportunities.

The 5G RAT under development by 3GPP, commonly referred to as “New Radio” or simply “NR,” is expected to make heavy use of beamforming. The antenna beams may be user-dependent and controlled by the precoding matrix indicator (PMI) reports, which are based on user equipment (UE) measurements performed on channel-state information reference signal (CSI-RS) symbols. Instead or in addition, fixed beams may be used, where the UE detects and measures each beam individually and continuously selects the best beam. The measurements in this case may be done using so-called mobility reference signal (MRS) symbols. The techniques described herein are, as a general matter, targeted to the user-dependent antenna beams controlled by the PMI reports, and thus the MRS-based beam selection is not discussed in further detail here. However, the techniques detailed herein are not necessarily limited to systems or scenarios where the antenna beams are user controlled, and are not limited in their applicability to measurements of CSI-RS symbols.

CSI-RS symbols are transmitted in the downlink, and are primarily intended to be used by UEs (3GPP terminology for wireless access terminals) to acquire channel state information (CSI). However, these CSI-RS symbols, which might be referred to by other names, could also serve other purposes. It should, in principle be possible to use CSI-RS for some or all of the following purposes:
1. Effective channel estimation at the UE: Frequency-selective CSI acquisition at the UE for a given downlink beam. Here, the measurements of CSI-RS may be used, for example, to support PMI and channel rank reporting.
2. Discovery signal: Measurement on a set of CSI-RS reference signals may be used to calculate a measurement parameter like the Reference Signal Received Power (RSRP) parameter defined by the 3GPP standards. The signals in this case are transmitted with a time density according to large-scale coherence time of the relevant downlink channels.
3. Beam refinement and tracking: Measurements of CSI-RS symbols may be used to obtain statistics about the downlink channel and PMI reporting, to support beam refinement and tracking. PMI does not need to be frequency selective. For these purposes, the CSI-RS symbols should be transmitted with a time density according to large-scale coherence time of the relevant downlink channels.
4. UE transmit beam-forming in the uplink: In some situations, reciprocity between the uplink and the downlink may be assumed, in which case measurements of CSI-RS symbols may be used for uplink beam-forming.
5. UE beam-scanning for analog receive beam-forming in the downlink: Here, requirements are similar to number 1 and 3 above, depending on the use-case.
6. Assisting fine-frequency/time-synchronization for demodulation.

In some cases, not all of the above estimation purposes need to be handled by CSI-RS. For instance, frequency offset estimation can sometimes be handled using downlink demodulation reference symbols (DL-DMRS), and beam-discovery may be handled using other reference symbols.

Each CSI-RS transmission is scheduled, and can either use some of the same frequency resources as a Physical Data Channel (PDCH) downlink transmission, or use frequency resources unrelated to the PDCH downlink data transmissions. In general, no interdependence between CSI-RS in different transmissions can be assumed, hence the UE should not perform filtering in time. However, it is possible to explicitly or implicitly configure a UE (via signalling) to assume interdependence between CSI-RS, for example, to support time-filtering of CSI-RS measurements. Interdependence to other transmissions including Physical Downlink Control Channel (PDCCH) and PDCH transmissions is also possible. In general, all UE filtering shall be controlled by the network, including filtering of CSI over time, across frequency, and over diversity branches.

In some transmission formats, CSI-RS is situated in a separate Orthogonal Frequency-Division Multiplexing (OFDM) symbol from other channels, to better support analog beam-forming, both for the base station transmitter (TX) and the UE receiver (RX). For example, to support UE analog beam-scanning, the UE needs multiple CSI-RS transmissions to measure on in order to scan multiple analog-beam candidates. FIG. 1 illustrates CSI-RS groups, sub-groups, and several configuration examples; in the example configuration labelled “Ex. 2” in FIG. 1, there are CSI-RS transmissions in four OFDM symbols, to facility the scanning of multiple analog-beam candidates.

As seen in the examples shown in FIG. 1, CSI-RS are grouped into sub-groups related to the possible reporting rank of the UE measurement. Each sub-group of CSI-RS represents a set of orthogonal reference signals that can share a set of time-frequency resource elements by code multiplexing; only a limited set of highest ranks is supported in this fashion, e.g., 2, 4 and 8. Multiple sub-groups within a group are created by assigning orthogonal sets of resource elements to the sub-groups. Measurements within a sub-group are for good correspondence with DL-DMRS. In addition, separate resource elements are used to better support measurements on non-serving beams.

A key enabler for allowing CSI-RS to fulfill requirements 1 to 6 above is the support of flexible configuration of the CSI-RS. For example, frequency offset estimation is enabled by configuring time repetition of the CSI-RS symbols. To facilitate the several different possible uses for CSI-RS, the design of CSI-RS groups and sub-groups should allow efficient multiplexing of UEs, with different configurations. Consider in FIG. 1, the three examples:
In Ex. 1, the UE is measuring on three CSI-RS sub-groups, in each resource block; one sub-group having rank 4; and two having rank 2. These are repeated across the frequency band.
In Ex. 2, the UE is configured with four consecutive (in the time-domain) identical resources that provide rank 2, e.g., to support requirement 5. These are sub-sampled in the frequency domain—as seen in the figure, this means that they are not repeated in every resource block.
In Ex. 3, the UE is rate matching data reception around the CSI-RS sub-group (rank-2) on the first OFDM symbol that contains CSI-RS, but not around the two sub-groups on the second OFDM symbol that contains CSI-RS. In other words, the PDCH is punctured by the CSI-RS in one of the illustrated OFDM symbols, but the other OFDM symbol carrying CSI-RS does not overlap the PDCH.

In an NA system, there may be a large number of CSI-RS symbols to be measured, corresponding to a large number of antennas and a large number of possible beams. Accordingly, improved techniques for handling these measurements and the corresponding evaluation of the measurements are needed.

### SUMMARY

If conventional approaches to CSI-RS measurement were to be used in an NR system, a UE would measure the CSI-RS symbols from all antennas and evaluate the performance of all possible beams, to find the optimum preceding in the base station and thus select the optimum beam to be transmitted from the base station. This approach, however, may require a lot of measurements on different CSI-RS symbols from different antennas or different antenna beam transmitted from the base station. These measurements and the corresponding evaluation may become too burdensome, and may increase the power consumption of the UE.

According to several embodiments of the presently disclosed techniques and apparatuses, a UE supports two reporting modes for CSI. One reporting mode is similar to the “legacy” mode that is used in LTE systems, for example, where the UE tries to find the “best” transmission configuration among all possible configurations. Another reporting mode, referred to herein as a “low-power mode” instead aims to find a transmission configuration that is “good enough,” e.g., that is characterized by a CSI-related measurement parameter that meets a particular threshold for quality. In this mode, the UE can report the first PMI or other CSI-related parameter that meets this requirement, thus avoiding the need to always measure and evaluate all CSI-RS symbols.

Some embodiments of the presently disclosed techniques relate to a method carried out by a wireless device operating in a wireless communications network, where the method includes a reporting quality threshold for a parameter related to channel state information (CSI) and performing a measurement for each of a plurality of beams from a first predetermined set of beams for evaluation. The method further includes evaluating the measurement for each of the plurality of beams against the reporting quality threshold, and discontinuing the performing and evaluating of measurements in response to determining that the reporting quality threshold is met for one of the beams, such that measurements are not performed and evaluated for one or more beams in the first predetermined set of beams. The method further includes reporting the CSI for the one of the beams to the wireless communications network.

Other embodiments are related to a corresponding method carried out by one or more network nodes operating in a wireless communications network, where this corresponding method includes a step of determining, for at least one wireless device operating in the wireless network, that a low-power mode for beam evaluation is to be selectively enabled for the at least one wireless device. The low-power mode for beam evaluation is a beam-evaluation mode in which measurements for each of a plurality of beams in a predetermined set of beams are performed and evaluated until a measurement for one of the plurality of beams meets a reporting quality threshold for a parameter related to CSI, upon which the CSI for the one of the plurality of beams is reported and measurements and evaluation are discontinued, such that measurements are not performed and evaluated for one or more beams in the first predetermined set of beams. This method further includes the step of sending, to the at least one wireless device, a reporting configuration message directing the at least one wireless device to operate in the low-power reporting mode for beam evaluation.

A wireless device according to some embodiments disclosed herein comprises radio-frequency circuitry and a processing circuit operatively connected to the radio-frequency circuitry, where the processing circuit is configured to determine a reporting quality threshold for a parameter related to CSI and to perform a measurement for each of a plurality of beams from a first predetermined set of beams for evaluation. The processing circuit is further configured to evaluate the measurement for each of the plurality of beams against the reporting quality threshold and to discontinue performing and evaluating measurements in response to determining that the reporting quality threshold is met for one of the beams, such that measurements are not performed and evaluated for one or more beams in the first predetermined set of beams. The processing circuit is further configured to report CSI for one of the beams to the wireless communications network, using the radio-frequency circuitry.

Likewise, embodiments disclosed herein include a system that comprises one or more network nodes, each network node comprising a processing circuit and a communications interface circuit operatively coupled to the processing circuit, where the one or more network nodes are adapted to determine, for at least one wireless device operating in the wireless network, that a low-power mode for beam evaluation is to be selectively enabled for the at least one wireless device. Again, the low-power mode for beam evaluation is a beam-evaluation mode in which measurements for each of a plurality of beams in a predetermined set of beams are performed and evaluated until a measurement for one of the plurality of beams meets a reporting quality threshold for a parameter related to CSI, upon which the CSI for the one of the plurality of beams is reported and measurements and evaluation are discontinued, such that measurements are not performed and evaluated for one or more beams in the first predetermined set of beams. The one or more network nodes are further configured to send, to the at least one wireless device, a reporting configuration message directing the at least one wireless device to operate in the low-power reporting mode for beam evaluation.

Other embodiments disclosed herein include computer program products and computer-readable media corresponding to the above-summarized methods and variants thereof.

### BRIEF DESCRIPTION OF THE FIGURES

FIG. 1 illustrates CSI-RS groups, sub-groups, and example configurations.

FIG. 2 shows options for beam shapes.

FIG. 3 illustrates an example CSI-RS allocation.

FIG. 4 illustrates an example CSI-RS allocation for MU-MIMO operation.

FIG. 5 is a process flow diagram illustrating an example method carried out by a wireless device and radio network equipment.

FIG. 6 is a block diagram illustrating components of an example wireless device.

FIG. 7 is a process flow diagram illustrating an example method implemented by a wireless device.

FIG. 8 is a block diagram illustrating components of an example network node.

FIG. 9 is a process flow diagram illustrating an example method implemented by a network node.

FIG. 10 is a block diagram illustrating another view of an example wireless device.

FIG. 11 is a block diagram illustrating another view of an example radio network node.

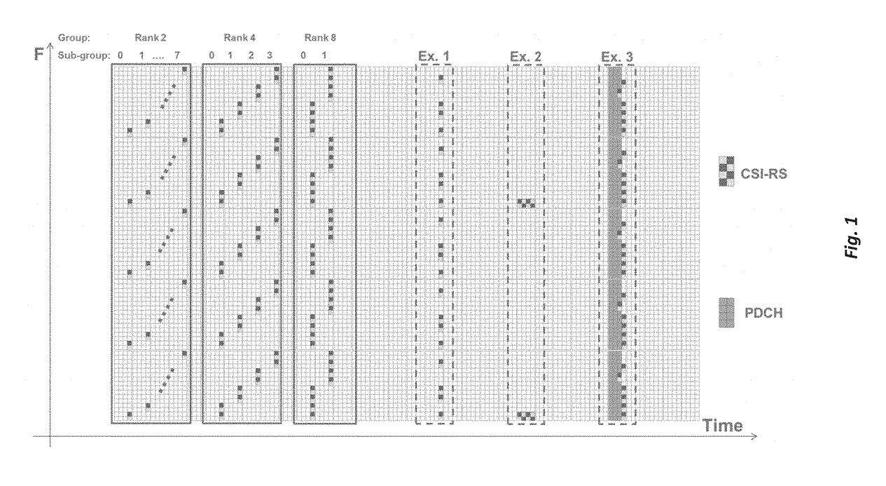

### DETAILED DESCRIPTION

In the discussion that follows, some details of a 5G wireless communications network in which the presently disclosed techniques might be used are provided. This wireless communications network, which includes wireless devices, radio access networks, and core networks, is referred to as “NR.” It should be understood that the term “NR” is used herein as simply a label, for convenience. Implementations of wireless devices, radio network equipment, network nodes, and networks that include some or all of the features detailed herein may, of course, be referred to by any of various names. In future development of specifications for 5G, for example, other terms may be used—it will be understood that some or all of the features described here may be directly applicable to these specifications. Likewise, while the various technologies and features described herein are targeted to a “5G” wireless communications network, specific implementations of wireless devices, radio network equipment, network nodes, and networks that include some or all of the features detailed herein may or may not be referred to by the term “5G.”

In this document, the term “wireless device” refers to a device capable, configured, arranged and/or operable to communicate wirelessly with network equipment and/or another wireless device. In the present context, communicating wirelessly involves transmitting and/or receiving wireless signals using electromagnetic signals. In particular embodiments, wireless devices may be configured to transmit and/or receive information without direct human interaction. For instance, a wireless device may be designed to transmit information to a network on a predetermined schedule, when triggered by an internal or external event, or in response to requests from the network. Generally, a wireless device may represent any device capable of, configured for, arranged for, and/or operable for wireless communication, for example radio communication devices. Examples of wireless devices include, but are not limited to, user equipment (UE) such as smart phones. Further examples include wireless cameras, wireless-enabled tablet computers, laptop-embedded equipment (LEE), laptop-mounted equipment (LME), USB dongles, and/or wireless customer-premises equipment (CPE).

As one specific example, a wireless device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. Instead, a UE may represent a device that is intended for sale to, or operation by, a human user but that may not initially be associated with a specific human user. It should also be appreciated that in the previous detailed discussion, the term “UE” is used, for convenience, even more generally, so as to include, in the context of the NX network, any type of wireless device that accesses and/or is served by the NX network, whether or not the UE is associated with a “user” per se. Thus, the term “UE” as used in the above detailed discussion includes machine-type-communication (MTC) devices (sometimes referred to as machine-to-machine, or M2M devices), for example, as well as handsets or wireless devices that may be associated with a “user.”

Some wireless devices may support device-to-device (D2D) communication, for example by implementing a 3GPP standard for sidelink communication, and may in this case be referred to as D2D communication devices.

As yet another specific example, in an Internet of Things (IOT) scenario, a wireless device may represent a machine or other device that performs monitoring and/or measurements, and transmits the results of such monitoring and/or measurements to another wireless device and/or a network equipment. A wireless device may in this case be a machine-to-machine (M2M) device, which may in a 3GPP context be referred to as a machine-type communication (MTC) device. As one particular example, a wireless device may be a UE implementing the 3GPP narrow band internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a wireless device may represent a vehicle or other equipment that is capable of monitoring and/or reporting on its operational status or other functions associated with its operation.

A wireless device as described above may represent the endpoint of a wireless connection, in which case the device may be referred to as a wireless terminal. Furthermore, a wireless device as described above may be mobile, in which case it may also be referred to as a mobile device or a mobile terminal.

Beam selection in NR and other wireless systems is based on channel-state information (CSI) reported to the network by UEs. The actual format of the CSI reports may vary, but may include, for example, a channel quality indicator (COI), which may in turn include a rank and a precoder matrix indicator (PMI). The CSI acquisition process thus involves the UE being assigned a CSI-RS from the serving node, which is used by the UE to calculate a rank, a precoder, and the resulting COI.

CSI-RSs are transmitted by the network according to CSI acquisition demands, and preferably only on the part of the bandwidth where there are current or expected future data transmissions. The base station (which is referred to as an “eNB” in LTE documentation, but may have other names in other specifications) makes the decision when to transmit CSI-RS and when the UE should report. Information on what CSI-RS resources to measure on are conveyed to the UE, over the downlink. In case of element-based feedback, it is possible to share, to a larger extent, CSI-RSs between UEs, and enable more filtering in comparison to more dynamic beam-based schemes. An additional potential benefit of sharing CSI-RS configurations is that the UEs can be more easily configured to rate-match around the common CSI-RS and hence utilized more resource elements for data.

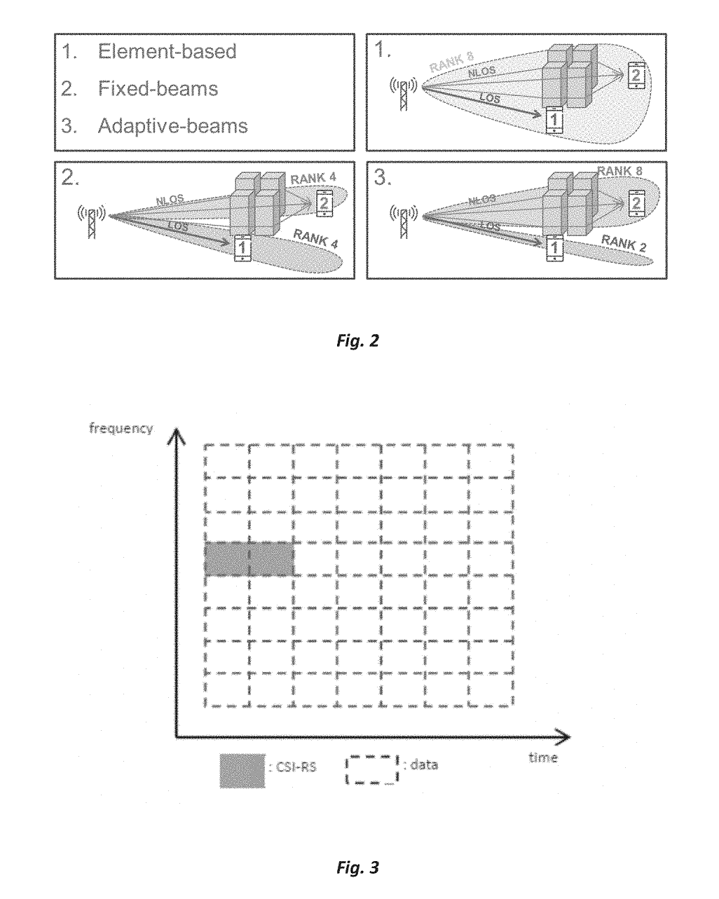

FIG. 2 illustrates options of beam shapes for feedback-based solutions in NR. Transmitting in a beam implies that there is a directional, possibly narrow, propagating stream of energy. The notion of a beam is thus closely related to the spatial characteristics of the transmission. To ease the discussion, the beam concept is first explained. In particular, the notion of a high-rank beam is described.

Here, a beam is defined as a set of beam weight vectors, where each beam weight vector has a separate antenna port, and all the antenna ports have similar average spatial characteristics. All antenna ports of a beam thus cover the same geographical area. Note, however, that the fast fading characteristics of different antenna ports may be different. One antenna port is then mapped to one or several antenna elements, using a possibly dynamic mapping. The number of antenna ports of a beam is the rank of the beam.

To illustrate the beam definition, take the most common example of a rank-2 beam. Such a beam is realized using an antenna with cross-polarized elements, where all antenna elements with one polarization are combined using one beam weight vector, and all antenna elements with the other polarization are combined using the same beam weight vector. Each beam weight vector has one antenna port, and since the same beam weight vector is used for the two antenna ports, the two beam weight vectors together constitute one rank-2 beam. This can then be extended to beams of higher rank.

Note that high-rank beams may not work for the UE. Due to the irregular antenna element layout, the rich scattering at the UE and the fact that the UE antenna elements may have different characteristics, it is very challenging to construct several beam weight vectors with similar spatial characteristics. Note that this does not preclude spatial multiplexing in the uplink: this can be achieved using several rank-1 beams.

It is important to note that the beam shapes can be quite flexible. Hence, “beam-based transmission” is not the same as “fixed-beam transmission”, although using a fixed grid of beams may be a suitable implementation in many cases. A useful working assumption is that each beam has between 1 and 8 ports, and that each beam is associated with a CSI-RS with a rank ranging from 1 to 8.

From the UE's point of view, no major difference to element-based feedback is foreseen for NR, compared to LTE, other than the CSI-RS configuration. For beam-based transmission, the CSI-RS allocations need to be more flexible. Even though the configuration is flexible this does not preclude that the UE may do filtering and interpolation, but this is under strict network control.

In beam-based transmission, communication occurs through beams, where the number of beams may be much smaller than the number of antenna elements. Since the beams are still adjustable, the antenna system as a whole retains all its degrees of freedom. However, a single UE may not be capable of supporting all these degrees of freedom using instantaneous feedback. Note that this is in contrast to element-based transmission, where the UE sees all the degrees of freedom of the antenna, and is capable of reporting based on this knowledge.

From the network's point of view, multiple simultaneous beams can be generated, either using analog beamforming or digital domain processing. It is assumed that as long as the formed beams are of similar width as the angular spread of the channel, the overhead to maintain the UE beam associations are reasonable; the best beam for any single UE does not then vary with the fast fading. When the beam is narrower than the angular spread of the channel, the best beam for any single UE varies over time, leading to that the best beam association needs to be frequently updated. In some cases, the antenna patterns are fixed—FIG. 2, option 2 illustrates the use of two fixed-beams, each with rank-4. In some cases, the beams are adapted to the UEs channel characteristics; this is shown in FIG. 2, option 3, where user 2 with a rich channel receives data through a wide high-rank beam (rank-8), while the line-of-sight (LOS) user 1 receives a narrow rank-2 beam. FIG. 2, option 1, shows element-based transmission.

Beam-based transmission is applicable in both Frequency-Division Duplexing (FDD) and Time-Division Duplexing (TDD) modes, for any frequency band, and antenna size.

In the downlink, the individual antenna elements may never be exposed to the UE, e.g., when massive antenna arrays. The UE in this case only sees a number of linear combinations of the signals transmitted from different antenna elements. The number of linear combinations that is exposed is determined by the rank of the transmission. Data is received at the UE through such a linear combination (the beam) and downlink quality is measured and reported per beam.

With beam-based transmission, the eNB in principle still has full flexibility in forming the desired beams, or equivalently using any precoding. The way to adjust the precoding is different for FDD and TDD, and it is different for different beamforming architectures.

Precoder selection is based on beam-formed CSI-RS that is inserted at specific locations in the time-frequency grid in line with the data. These CSI-RSs are activated on demand, and the eNB decides through which beam the CSI-RS is transmitted. It is assumed that when scheduled, one CSI-RS uses one resource element. Each CSI-RS may be transmitted in different beam, transparent to the UE. One example of a CSI-RS allocation, where two CSI-RSs are transmitted, is shown in FIG. 3.

Both time- and frequency-multiplexing of CSI-RS should be supported, but it should be noted that for beamforming architectures that are not fully digital, transmitting different CSI-RSs at different points in time uses less baseband hardware than transmitting different CSI-RSs at the same time in different subcarriers. On the other hand, transmitting several CSI-RSs in different subcarriers at the same time means that more beams can be measured at the same time.

To enable link adaptation, one of the CSI-RSs can be transmitted over the same beam as the currently scheduled data. Other CSI-RSs may be transmitted through other candidate beams, and the selection of these candidate precoders is the responsibility of the eNB. Still, this is transparent to the UE; only the eNB knows which CSI-RS is transmitted through which beam. For some CSI-RS allocations, observe that if a CSI-RS has high rank and or multiple associated UEs a precoder assumption can be desirable to improve link adaptation accuracy in the multi-user multiple-input multiple-output (MU-MIMO) case, both for interference estimation and signal quality estimation.

The number of CSI-RSs that are required depends on how many candidate beams need to be probed and also how frequent updates are required. Note that in many cases, the number of beams that need to be probed may not be very large. For instance, only two CSI-RSs may be assigned in each subframe, and transmitting through different candidate beams in subsequent subframes. To cater to this flexibility, the CSI-RSs allocation can be signaled to the UE in the downlink control information (DCI) field. Since the CSI-RS is transmitted in line with the data, the amount of payload data needs to be reduced to make room for the CSI-RS. The amount of overhead varies depending on how many UEs are active, and the flexibility that is desired in the CSI-RS mapping.

Closed-loop codebook based precoding over the all the antenna ports of a beam is likely to be used in NR, very similar to how it is done in LTE today. The UE measures the CSI-RS transmitted on the antenna ports, derives the most suitable precoding matrix from the codebook using the CSI-RS measurements, and sends an indication of the most suitable precoding matrix to the eNB. Thus, the antenna port precoder is determined by the UE, based on one high-rank CSI-RS, whereas the beam is selected by comparing the CQIs reported by the UEs for different candidate beams. If a beam has higher rank than 2, the precoders would be of larger size and hence operate also over the spatial domain. As in LTE, the codebook for the precoder needs to be standardized.

When a UE is allocated multiple beams, the UE has been assigned several CSI-RSs and each CSI-RS has a certain rank. In at least one mode, the UE measures on all allocated CSI-RS, and selects the most suitable antenna port precoder from the codebook. For each of the CSI-RSs, the UE transmits a precoder index, a CQI value and a rank indicator. These parameters may be referred to as a CSI report, but it will be appreciated that other contents and formats for CSI reports are possible.

Upon reception of the CSI report, the eNB maps each CSI report to the beam it was transmitted in. The eNB chooses the beam for the subsequent transmissions based on the reported CQI values, and also selects the precoder based on the suggestion from the UE. The CQI value is also used to select modulation and coding for the next transmission.

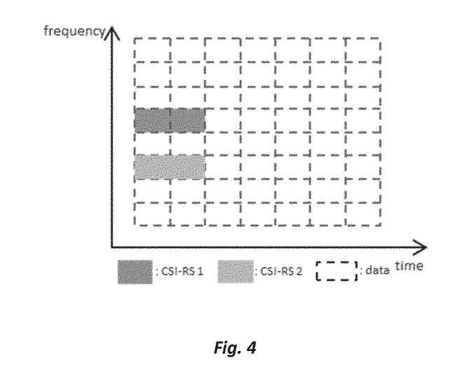

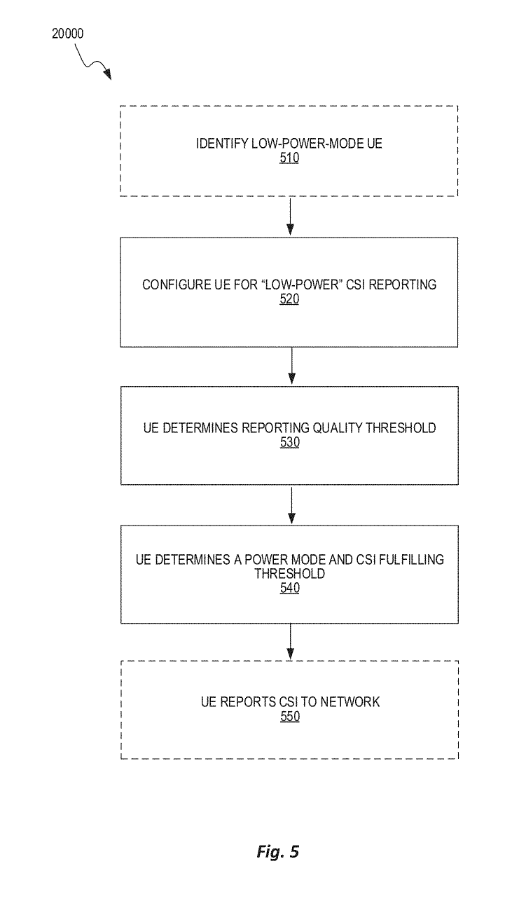

Note that the CSI-RS measurement scheme works also for MU-MIMO. Different UEs are assigned different CSI-RS allocations, as shown in the proposed CSI-RS allocation for MU-MIMO operation shown in FIG. 4, where CSI-RS 1 is for a first user, and CSI-RS 2 is for a second user. In the resource elements where the CSI-RS is transmitted to one user, interference from the data transmissions to the other user is measured, and vice versa. Hence, both measurements reflect the current interference properties of the co-scheduled user.

The starting point for one possible design is that the CSI-RSs are UE-specific, where each UE is assigned a distinct set of CSI-RSs to measure on. To reap the full benefits of the antenna system, the network also needs to transmit individual CSI-RSs through UE-specific candidate beams. This means that when there are many active UEs in a cell, quite many CSI-RS transmissions are needed. In that case, there may be an option to let several users measure on the same CSI-RSs, for example, by mapping the CSI-RS to a grid of beams.

According to conventional approaches for beam refinement, the selection of the best downlink beam for a UE is based on UE measurements on downlink signals. The beam can be selected by measuring reference symbols, CSI-RS, corresponding to each antenna in the antenna array in the base-station/radio-head. In Long-Term Evolution (LTE) systems, CSI-RS symbols are transmitted from each antenna of the base-station and are used by the UE to calculate the precoding that should be used in the base-station to transmit the beam giving the best downlink coverage to the UE. Alternatively, the UE may measure the received quality from each of several beams transmitted from the base station/radio head. In either case, in a system with many transmit antennas in the base station and thereby many possible beams to transmit, there is a considerable effort by the UE to find the best beam.

These measurements require effort in the UEs. In the event that there are many transmit antennas with CSI-RS symbols, or similarly, many possible transmit beams, the rate of the CSI-RS symbols on a per-antenna or per-beam basis will be quite low. Therefore, depending on the solution, it may take extra time with an active radio to receive all CSI-RS symbols, or to receive signals from all possible beams. Furthermore, if the CSI-RS solution is used, the effort to calculate the optimum precoder is also dependent on the number of transmitters used in the base-station.

As discussed above, if conventional approaches to CSI-RS measurement were to be used in an NR system, a UE would measure the CSI-RS symbols from all antennas and evaluate the performance of all possible beams, to find the optimum preceding in the base station and thus select the optimum beam to be transmitted from the base station. This approach, however, may require a lot of measurements on different CSI-RS symbols from different antennas or different antenna beam transmitted from the base station. These measurements and the corresponding evaluation may become too burdensome, and may increase the power consumption of the UE.

The techniques described herein address this problem by providing for a power-saving mode, where a UE, when it is in the power-save mode, e.g., when there is only a limited amount of data that it is expected to receive, can limit the amount of measurements by searching for a “good-enough” beam, rather than the “best” beam. A UE with very low downlink data-traffic, for example, does not need to use the optimum downlink beam in order to receive the data. Instead it can have a threshold defining a beam quality that is good enough to receive data. That threshold may be absolute, in some embodiments, but may also be defined so that it takes the estimated propagation delay into account, so that the downlink transmission does not transmit with very much higher power than needed.

Thus, according to several embodiments of the presently disclosed techniques and apparatuses, a UE supports two reporting modes for CSI. One reporting mode is similar to the “legacy” mode that is used in LTE systems, for example, where the UE tries to find the “best” transmission configuration among all possible configurations. Another reporting mode, referred to herein as a “low-power mode” instead aims to find a transmission configuration that is “good enough,” e.g., that is characterized by a CSI-related measurement parameter that meets a particular threshold for quality. In this mode, the UE can report the first PMI or other CSI-related parameter that meets this requirement, thus avoiding the need to always measure and evaluate all CSI-RS symbols.

An advantage of these embodiments is that under many circumstances, UEs can use a CSI reporting mode that saves a significant amount of energy, as less time is spent measuring and evaluating CSI-RS. These circumstances may include, for example, situations where the UE needs only to send or receive a relatively few packets and/or small packets, such that optimizing the beam quality is not necessary. Further advantages may accrue in embodiments where the network controls the quality threshold used to select the beam—in these embodiments, the network can manage the trade-off between UE duty cycle and the extra overhead that might be needed for signaling towards the UE in the event that the network utilizes a less than optimal beam-configuration when communicating with the UE, as a result of the non-exhaustive CSI measurements performed by the UE.

According to several embodiments, then, measurement efforts can be limited to the CSI-RS symbols from a subset of the antenna transmissions, in order to calculate a PMI, e.g., to define a beam that is good enough to have a slow data connection from the base-station to the UE. This beam will probably be wider and less sensitive to movements as well. In that case, the rate of measurements can be decreased as well. If the measurements are not based on finding the best beam, the measurement can focus on finding a beam that is good enough so that the UE can receive the expected downlink data.

In some embodiments, the UE makes the decision based, not only on the power mode and quality threshold, but also on the availability of the channel in the different directions. This is applicable, for instance in unlicensed bands, e.g., where a listen-before-talk (LBT) operation might fail in one direction but succeed in another.

To re-state and expand upon some of the above discussion, in NR, the amount of CSI generally increases with the number of antennas/beams, meaning that the number of evaluations of beams/hypothesis performed by the UE can increase accordingly. This will in turn lead to an increase in UE power consumption.

One approach to address this, and to thus lower UE power consumption, is to have at least two reporting modes for CSI. One mode is a mode where the UE or other wireless device seeks the “best” transmission configuration. This may be regarded as a “default” or “legacy” mode. Another mode may be referred to as a “low-power mode,” and is based on the use of a threshold for the quality of the reported CSI (e.g., PMI). In this mode, the UE reports (to the wireless network) the first CSI/PMI that meets a quality threshold requirement. Thus, rather than finding the absolute best possible transmission configuration, the UE instead finds one that is sufficient to meet the quality threshold requirement, and reports it, reducing UE power consumption by not necessarily seeking the absolute best possible transmission configuration. In certain embodiments, the UE may select the threshold for the quality of the reported CSI by itself, based on pre-programmed quality thresholds or other selection criteria. In alternative embodiments, the UE may receive a direction from the network as to the threshold for the quality of the reported CSI, and select the directed threshold.

In some embodiments, this low power mode may involve the UE only scanning a subset of the PMI, for example. This low power mode may also involve the UE turning off one or more receiver/transmitter chains or, more generally, switching one or more receiver and/or transmitter circuits to a low-power state while operating in the low power mode, such that the circuits consume less power in this low-power state relative to their power consumption in the default mode.

FIG. 5 illustrates a process flow diagram according to an embodiment of this approach. The illustrated method includes steps performed by the network, e.g., in radio network equipment, as well as in a wireless device (e.g., a UE). It will be appreciated that embodiments may include all or some of the network-side steps, or some or all of the UE-side steps, or both.

As shown at block 510, the method may, in some embodiments, include identifying a UE capable of the low-power mode, e.g., using capability information known to the network, or identifying a UE for which operation in the low-power mode is particularly suitable, e.g., because traffic to and/or from the UE is expected to be low. In FIG. 5, block 510 is shown with a dashed outline, to indicate that the illustrated step may not be present in every implementation or instance of the method, since, for example, some embodiments may activate a low-power reporting mode for all UEs, e.g., based on system load or some other parameter, rather than on a UE-to-UE basis. In some embodiments, a UE may be deemed to be one for which a low-power CSI reporting mode is suitable based on determining that only limited data traffic is needed or anticipated for the UE, e.g., where only control signalling is needed. In some embodiments, a UE may be identified as a low-power UE based on its type or according to its general mode of operation, e.g., as known by or as identified to the system.

The illustrated method further comprises, as shown at block 520, configuring the UE for low-power channel-state information (CSI) reporting, e.g., using RRC signaling. As shown at block 530, the UE determines a reporting quality threshold for one or more CSI-related parameters—this may be determined from configuration information provided to the UE by the network, in some embodiments, or from pre-programmed quality thresholds, in other embodiments, or by some combination of both. In some embodiments, the threshold may be calculated based on an expected data rate for the UE. It will be appreciated that in some embodiments there may be a set of thresholds. There may be one threshold on path-loss calculated from the transmitted and received power, and/or another threshold based on the estimated SNR/SINR. If the path-loss is big, it might mean either that the UE is close to the base station but the beam is transmitted in another direction, or that the UE is far from the base station. In either case, the transmission requires higher power to reach the UE on that beam, and the UE needs to find a better beam, where the path loss is lower. The other threshold on the received SNR/SINR means that the UE is observing poor SNR/SINR performance from that beam; in order to improve SINR, the UE needs to find a better beam.

As shown at block 540, the UE performs evaluations of received signals for one or more beams and/or cells, and determines a power mode and CSI that meets the quality threshold. In other words, the UE performs CSI-RS measurements (or similar measurements) until a beam meeting the quality threshold(s) is identified. Note that if no beam fulfilling the quality threshold(s) is found, the UE is effectively out of the low-power mode, and thus finds and reports the best beam. As shown at block 550, the UE, in some embodiments or in some instances, reports the CSI for at least one beam that meets the quality threshold(s) or, if one is not found, the best beam.

It will be appreciated that the UE may go in and out of the low-power mode, depending on the thresholds and whether beams are found that meet the thresholds. In some embodiments, the network may instruct the UE to enter or leave the low-power mode. In some embodiments, for example, a network may enable the low-power mode depending on network load. Because spectral efficiency is not as critical with low network loads, the network may be able to accommodate the loss in spectral efficiency that may arise from UEs using less-than-optimal beams. In these embodiments, the network may activate or enable the low-power mode for all UEs served by a particular base station or group of base stations, e.g., using broadcast signaling. In some embodiments, as suggested above, the network may specifically identify one or more UEs as having a need for low-power operation. This might be based on UE category, such as by identifying that a UE is a machine-type-communication (MTC) device, and/or might be based on determining that the expected data traffic for the UE, i.e., the expected frequency and size of data packets for the UE, is relatively low, e.g., below a certain configuration threshold. In these embodiments, the network may specifically enable the low-power reporting mode for these identified UEs, e.g., using UE-specific control signaling, while other UEs in the same area may continue to use the legacy CSI reporting mechanisms.

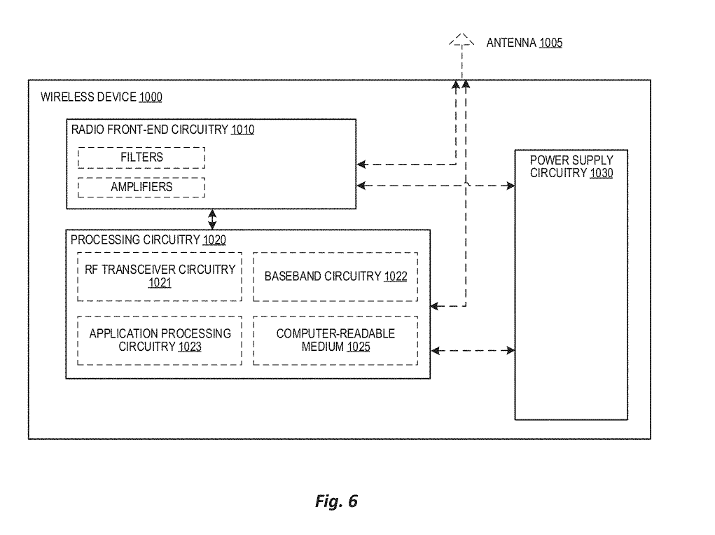

Although it will be appreciated that specific embodiments of the UEs and wireless devices discussed herein may include any of various suitable combinations of hardware and/or software, a wireless device configured to operate in the wireless communications networks described herein and/or according to the various techniques described herein may, in particular embodiments, be represented by the example wireless device 1000 shown in FIG. 6.

As shown in FIG. 6, example wireless device 1000 includes an antenna 1005, radio front-end circuitry 1010, and processing circuitry 1020, which in the illustrated example includes a computer-readable storage medium 1025, e.g., one or more memory devices. Antenna 1005 may include one or more antennas or antenna arrays, and is configured to send and/or receive wireless signals, and is connected to radio front-end circuitry 1010. In certain alternative embodiments, wireless device 1000 may not include antenna 1005, and antenna 1005 may instead be separate from wireless device 1000 and be connectable to wireless device 1000 through an interface or port.

Radio front-end circuitry 1010, which may comprise various filters and amplifiers, for example, is connected to antenna 1005 and processing circuitry 1020 and is configured to condition signals communicated between antenna 1005 and processing circuitry 1020. In certain alternative embodiments, wireless device 1000 may not include radio front-end circuitry 1010, and processing circuitry 1020 may instead be connected to antenna 1005 without radio front-end circuitry 1010. In some embodiments, radio-frequency circuitry 1010 is configured to handle signals in multiple frequency bands, in some cases simultaneously.

Processing circuitry 1020 may include one or more of radio-frequency (RF) transceiver circuitry 1021, baseband processing circuitry 1022, and application processing circuitry 1023. In some embodiments, the RF transceiver circuitry 1021, baseband processing circuitry 1022, and application processing circuitry 1023 may be on separate chipsets. In alternative embodiments, part or all of the baseband processing circuitry 1022 and application processing circuitry 1023 may be combined into one chipset, and the RF transceiver circuitry 1021 may be on a separate chipset. In still alternative embodiments, part or all of the RF transceiver circuitry 1021 and baseband processing circuitry 1022 may be on the same chipset, and the application processing circuitry 1023 may be on a separate chipset. In yet other alternative embodiments, part or all of the RF transceiver circuitry 1021 baseband processing circuitry 1022, and application processing circuitry 1023 may be combined in the same chipset. Processing circuitry 1020 may include, for example, one or more central processing units (CPUs), one or more microprocessors, one or more application specific integrated circuits (ASICs), and/or one or more field programmable gate arrays (FPGAs).

In particular embodiments, some or all of the functionality described herein as relevant to a user equipment, MTC device, or other wireless device may be embodied in a wireless device or, as an alternative, may be embodied by the processing circuitry 1020 executing instructions stored on a computer-readable storage medium 1025, as shown in FIG. 6. In alternative embodiments, some or all of the functionality may be provided by the processing circuitry 1020 without executing instructions stored on a computer-readable medium, such as in a hard-wired manner. In any of those particular embodiments, whether executing instructions stored on a computer-readable storage medium or not, the processing circuitry 1020 can be said to be configured to perform the described functionality. The benefits provided by such functionality are not limited to the processing circuitry 1020 alone or to other components of the wireless device, but are enjoyed by the wireless device as a whole, and/or by end users and the wireless network generally.

The processing circuitry 1020 may be configured to perform any determining operations described herein. Determining as performed by processing circuitry 1020 may include processing information obtained by the processing circuitry 1020 by, for example, converting the obtained information into other information, comparing the obtained information or converted information to information stored in the wireless device, and/or performing one or more operations based on the obtained information or converted information, and as a result of said processing making a determination.

Antenna 1005, radio front-end circuitry 1010, and/or processing circuitry 1020 may be configured to perform any transmitting operations described herein. Any information, data and/or signals may be transmitted to a network equipment and/or another wireless device. Likewise, antenna 1005, radio front-end circuitry 1010, and/or processing circuitry 1020 may be configured to perform any receiving operations described herein as being performed by a wireless device. Any information, data and/or signals may be received from a network equipment and/or another wireless device.

Computer-readable storage medium 1025 is generally operable to store instructions, such as a computer program, software, an application including one or more of logic, rules, code, tables, etc. and/or other instructions capable of being executed by a processor. Examples of computer-readable storage medium 1025 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or any other volatile or non-volatile, non-transitory computer-readable and/or computer-executable memory devices that store information, data, and/or instructions that may be used by processing circuitry 1020. In some embodiments, processing circuitry 1020 and computer-readable storage medium 1025 may be considered to be integrated.

Alternative embodiments of the wireless device 1000 may include additional components beyond those shown in FIG. 6 that may be responsible for providing certain aspects of the wireless device's functionality, including any of the functionality described herein and/or any functionality necessary to support the solution described above. As just one example, wireless device 1000 may include input interfaces, devices and circuits, and output interfaces, devices and circuits. Input interfaces, devices, and circuits are configured to allow input of information into wireless device 1000, and are connected to processing circuitry 1020 to allow processing circuitry 1020 to process the input information. For example, input interfaces, devices, and circuits may include a microphone, a proximity or other sensor, keys/buttons, a touch display, one or more cameras, a USB port, or other input elements. Output interfaces, devices, and circuits are configured to allow output of information from wireless device 1000, and are connected to processing circuitry 1020 to allow processing circuitry 1020 to output information from wireless device 1000. For example, output interfaces, devices, or circuits may include a speaker, a display, vibrating circuitry, a USB port, a headphone interface, or other output elements. Using one or more input and output interfaces, devices, and circuits, wireless device 1000 may communicate with end users and/or the wireless network, and allow them to benefit from the functionality described herein.

As another example, wireless device 1000 may include power supply circuitry 1030. The power supply circuitry 1030 may comprise power management circuitry. The power supply circuitry may receive power from a power source, which may either be comprised in, or be external to, power supply circuitry 1030. For example, wireless device 1000 may comprise a power source in the form of a battery or battery pack which is connected to, or integrated in, power supply circuitry 1030. Other types of power sources, such as photovoltaic devices, may also be used. As a further example, wireless device 1000 may be connectable to an external power source (such as an electricity outlet) via an input circuitry or interface such as an electrical cable, whereby the external power source supplies power to power supply circuitry 1030.

Power supply circuitry 1030 may be connected to radio front-end circuitry 1010, processing circuitry 1020, and/or computer-readable storage medium 1025 and be configured to supply wireless device 1000, including processing circuitry 1020, with power for performing the functionality described herein.

Wireless device 1000 may also include multiple sets of processing circuitry 1020, computer-readable storage medium 1025, radio circuitry 1010, and/or antenna 1005 for different wireless technologies integrated into wireless device 1000, such as, for example, GSM, WCDMA, LTE, NR, WiFi, or Bluetooth wireless technologies. These wireless technologies may be integrated into the same or different chipsets and other components within wireless device 1000.

Wireless device 1000, in various embodiments, is adapted to carry out any of a variety of combinations of the features and techniques described herein.

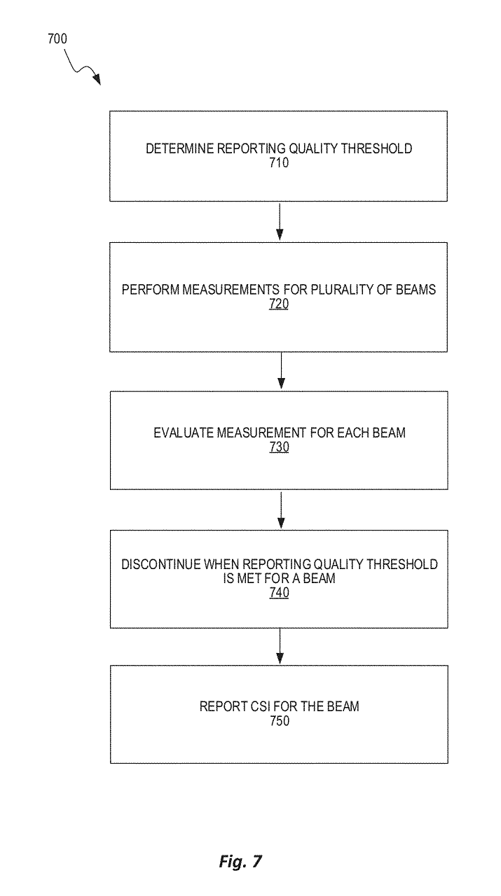

In some embodiments, wireless device 1000 is adapted to carry out one or more of the techniques described above. For example, in some embodiments, the components of wireless device 1000, and in particular processing circuitry 1020, are configured to carry out the UE-related steps in the process shown in FIG. 5, alone or in combination with one or more of any of the other techniques described above. In some of these and in some other embodiments, the wireless device 1000, and in particular processing circuitry 1020, are configured to carry out a method like that shown in FIG. 7.

In these embodiments, wireless device 1000 is adapted to determine a reporting quality threshold for a parameter related to channel state information (CSI), as shown at block 710 of FIG. 7, and to perform a measurement for each of a plurality of beams from a first predetermined set of beams for evaluation, as shown at block 720. The wireless device is further adapted to evaluate the measurement for each of the plurality of beams against the reporting quality threshold, as shown at block 730, and to discontinue the performing and evaluating of measurements in response to determining that the reporting quality threshold is met for one of the beams, such that measurements are not performed and evaluated for one or more beams in the first predetermined set of beams, as shown at block 740. As shown at block 750, the method carried out by wireless device 1000 may further comprise reporting, to the wireless communications network, CSI for the one of the beams.

In some embodiments, these operations are carried out during a first time interval, in a first reporting mode, and the wireless device 1000 is further adapted to, during a second time interval, in a second reporting mode: perform a measurement for each beam in a second predetermined set of beams for evaluation; identify, based on the measurements, a best beam according to one or more predetermined criteria; and report, to the wireless communications network, CSI for the best beam. In some of these latter embodiments, the wireless device is further adapted to receive a reporting configuration message from the wireless communication network, the reporting configuration message directing the wireless device to operate in the second reporting mode. In some embodiments, the wireless device is adapted to switch one or more receiver and/or transmitter circuits to a low-power state while operating in the first reporting mode, such that the receiver and/or transmitter circuits consume less power in the first reporting mode relative to the second reporting mode. In some embodiments, the wireless device is adapted to determine the reporting quality threshold by receiving the reporting quality threshold or an indication of the reporting quality threshold from the wireless communications network.

In some embodiments of the method shown in FIG. 7, e.g., as implemented by the wireless device 1000 of FIG. 6, determining the reporting quality threshold comprises calculating the reporting quality threshold based on an expected data rate. In some embodiments, the reporting quality threshold is a path-loss threshold corresponding to estimated path-losses for each of the beams for which measurements are performed. In other embodiments, the reporting quality threshold is a signal-to-interference ratio (SIR) threshold or a signal-to-noise-plus-interference (SINR) threshold, corresponding to estimated SIR or SINR for each of the beams for which measurements are performed. It will be appreciated that multiple thresholds may be used, in some embodiments.

In some embodiments, the reporting quality threshold a propagation delay threshold, which is compared to an estimated propagation delay for each of one or more of the plurality of beams. In some embodiments, determining the reporting quality threshold is based on a buffer status for the wireless device. For instance, if a transmit buffer for the wireless device is very low, the threshold might be reduced, in some embodiments, compared to when the transmit buffer is high, allowing the wireless device to select a beam of lesser quality.

In some embodiments of the method shown in FIG. 7, e.g., as implemented by the wireless device 1000 of FIG. 6, the discontinuing of the performing and evaluating of measurements is further in response to evaluating an availability of a radio channel in a direction of the one of the beams. In some of these embodiments, for example, evaluating the availability of the radio channel in the direction of the one of the beams is based on previous experience with listen-before-talk (LBT) operation in the direction of the one of the beams, or based on previous experience with LBT operation in one or more directions other than the direction of the one of the beams, or both.

As used herein, the term “network node” is used to refer to nodes in the radio access network and core network of the wireless communications system. The narrower term “radio network equipment” is used to refer to network nodes and network equipment that includes radio capabilities. Thus, examples of radio network nodes are the radio base stations and radio access points discussed above. It will be appreciated that some radio network equipment may comprise equipment that is distributed—such as the distributed radio base stations (with RRHs and/or RRUs) discussed above. It will be appreciated that the various references herein to eNBs, eNodeBs, Node Bs, and the like are referring to examples of radio network equipment. It should also be understood that the term “radio network equipment” as used herein may refer to a single base station or a single radio node, in some cases, or to multiple base stations or nodes, e.g., at different locations. In some cases, this document may refer to an “instance” of radio network equipment, to more clearly describe certain scenarios where multiple distinct embodiments or installations of radio equipment are involved. However, the lack of reference to an “instance” in connection with a discussion of radio network equipment should not be understood to mean that only a single instance is being referred to. A given instance of radio network equipment may alternatively be referred to as a “radio network node,” where the use of the word “node” denotes that the equipment referred to operate as a logical node in a network, but does not imply that all components are necessarily co-located.

While radio network equipment may include any suitable combination of hardware and/or software, an example of an instance of radio network equipment 1100 is illustrated in greater detail by FIG. 8. As shown in FIG. 8, example radio network equipment 1100 includes an antenna 1105, radio front-end circuitry 1110, and processing circuitry 1120, which in the illustrated example includes a computer-readable storage medium 1025, e.g., one or more memory devices. Antenna 1105 may include one or more antennas or antenna arrays, and is configured to send and/or receive wireless signals, and is connected to radio front-end circuitry 1110. In certain alternative embodiments, radio network equipment 1100 may not include antenna 1005, and antenna 1005 may instead be separate from radio network equipment 1100 and be connectable to radio network equipment 1100 through an interface or port. In some embodiments, all or parts of radio front-end circuitry 1110 may be located at one or several locations apart from the processing circuitry 1120, e.g., in a RRH or RRU. Likewise, portions of processing circuitry 1120 may be physically separated from one another. Radio network equipment 1100 may also include communication interface circuitry 1140 for communicating with other network nodes, e.g., with other radio network equipment and with nodes in a core network.

Radio front-end circuitry 1110, which may comprise various filters and amplifiers, for example, is connected to antenna 1105 and processing circuitry 1120 and is configured to condition signals communicated between antenna 1105 and processing circuitry 1120. In certain alternative embodiments, radio network equipment 1100 may not include radio front-end circuitry 1110, and processing circuitry 1120 may instead be connected to antenna 1105 without radio front-end circuitry 1110. In some embodiments, radio-frequency circuitry 1110 is configured to handle signals in multiple frequency bands, in some cases simultaneously.

Processing circuitry 1120 may include one or more of RF transceiver circuitry 1121, baseband processing circuitry 1122, and application processing circuitry 1123. In some embodiments, the RF transceiver circuitry 1121, baseband processing circuitry 1122, and application processing circuitry 1123 may be on separate chipsets. In alternative embodiments, part or all of the baseband processing circuitry 1122 and application processing circuitry 1123 may be combined into one chipset, and the RF transceiver circuitry 1121 may be on a separate chipset. In still alternative embodiments, part or all of the RF transceiver circuitry 1121 and baseband processing circuitry 1122 may be on the same chipset, and the application processing circuitry 1123 may be on a separate chipset. In yet other alternative embodiments, part or all of the RF transceiver circuitry 1121, baseband processing circuitry 1122, and application processing circuitry 1123 may be combined in the same chipset. Processing circuitry 1120 may include, for example, one or more central CPUs, one or more microprocessors, one or more ASICs, and/or one or more field FPGAs.

In particular embodiments, some or all of the functionality described herein as being relevant to radio network equipment, radio base stations, eNBs, etc., may be embodied in radio network equipment or, as an alternative may be embodied by the processing circuitry 1120 executing instructions stored on a computer-readable storage medium 1125, as shown in FIG. 8. In alternative embodiments, some or all of the functionality may be provided by the processing circuitry 1120 without executing instructions stored on a computer-readable medium, such as in a hard-wired manner. In any of those particular embodiments, whether executing instructions stored on a computer-readable storage medium or not, the processing circuitry can be said to be configured to perform the described functionality. The benefits provided by such functionality are not limited to the processing circuitry 1120 alone or to other components of the radio network equipment, but are enjoyed by the radio network equipment 1100 as a whole, and/or by end users and the wireless network generally.

The processing circuitry 1120 may be configured to perform any determining operations described herein. Determining as performed by processing circuitry 1120 may include processing information obtained by the processing circuitry 1120 by, for example, converting the obtained information into other information, comparing the obtained information or converted information to information stored in the radio network equipment, and/or performing one or more operations based on the obtained information or converted information, and as a result of said processing making a determination.

Antenna 1105, radio front-end circuitry 1110, and/or processing circuitry 1120 may be configured to perform any transmitting operations described herein. Any information, data and/or signals may be transmitted to any network equipment and/or a wireless device. Likewise, antenna 1105, radio front-end circuitry 1110, and/or processing circuitry 1120 may be configured to perform any receiving operations described herein as being performed by a radio network equipment. Any information, data and/or signals may be received from any network equipment and/or a wireless device.

Computer-readable storage medium 1125 is generally operable to store instructions, such as a computer program, software, an application including one or more of logic, rules, code, tables, etc. and/or other instructions capable of being executed by a processor. Examples of computer-readable storage medium 1125 include computer memory (for example, RAM or ROM), mass storage media (for example, a hard disk), removable storage media (for example, a CD or a DVD), and/or any other volatile or non-volatile, non-transitory computer-readable and/or computer-executable memory devices that store information, data, and/or instructions that may be used by processing circuitry 1120. In some embodiments, processing circuitry 1120 and computer-readable storage medium 1125 may be considered to be integrated.

Alternative embodiments of the radio network equipment 1100 may include additional components beyond those shown in FIG. 8 that may be responsible for providing certain aspects of the radio network equipment's functionality, including any of the functionality described herein and/or any functionality necessary to support the solution described above. As just one example, radio network equipment 1100 may include input interfaces, devices and circuits, and output interfaces, devices and circuits. Input interfaces, devices, and circuits are configured to allow input of information into radio network equipment 1100, and are connected to processing circuitry 1120 to allow processing circuitry 1120 to process the input information. For example, input interfaces, devices, and circuits may include a. microphone, a proximity or other sensor, keys/buttons, a touch display, one or more cameras, a USB port, or other input elements. Output interfaces, devices, and circuits are configured to allow output of information from radio network equipment 1100, and are connected to processing circuitry 1120 to allow processing circuitry 1120 to output information from radio network equipment 1100. For example, output interfaces, devices, or circuits may include a speaker, a display, a USB port, a headphone interface, or other output elements. Using one or more input and output interfaces, devices, and circuits, radio network equipment 1100 may communicate with end users and/or the wireless network, and allow them to benefit from the functionality described herein.

As another example, radio network equipment 1100 may include power supply circuitry 1130. The power supply circuitry 1130 may comprise power management circuitry. The power supply circuitry 1130 may receive power from a power source, which may either be comprised in, or be external to, power supply circuitry 1130. For example, radio network equipment 1100 may comprise a power source in the form of a battery or battery pack which is connected to, or integrated in, power supply circuitry 1130. Other types of power sources, such as photovoltaic devices, may also be used. As a further example, radio network equipment 1100 may be connectable to an external power source (such as an electricity outlet) via an input circuitry or interface such as an electrical cable, whereby the external power source supplies power to power supply circuitry 1130.

Power supply circuitry 1130 may be connected to radio front-end circuitry 1110, processing circuitry 1120, and/or computer-readable storage medium 1125 and be configured to supply radio network equipment 1100, including processing circuitry 1120, with power for performing the functionality described herein.

Radio network equipment 1100 may also include multiple sets of processing circuitry 1120, computer-readable storage medium 1125, radio circuitry 1110, antenna 1105 and/or communication interface circuitry 1140 for different wireless technologies integrated into radio network equipment 1100, such as, for example, GSM, WCDMA, LTE, NR, WiFi, or Bluetooth wireless technologies. These wireless technologies may be integrated into the same or different chipsets and other components within radio network equipment 1100.

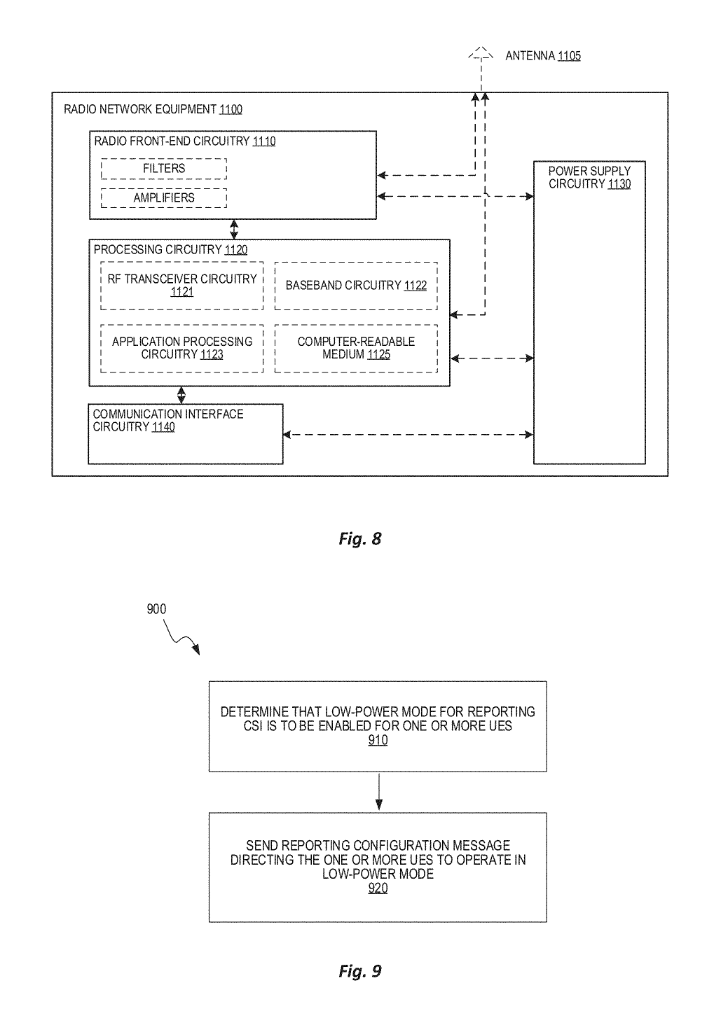

One or more instances of the radio network equipment 1100 may be adapted to carry out some or all of the techniques described herein, in any of various combinations. Thus, for example, one or more radio network nodes 1100 or one or more other network nodes operating in a wireless communications network may be configured to carry out a method like method 900, illustrated in FIG. 9. As shown at block 910, this method comprises determining for at least one wireless device operating in the wireless network, that a low-power mode for beam evaluation is to be selectively enabled for the at least one wireless device. As discussed extensively above, the low-power mode for beam evaluation is a beam-evaluation mode in which measurements for each of a plurality of beams in a predetermined set of beams are performed and evaluated until a measurement for one of the plurality of beams meets a reporting quality threshold for a parameter related to CSI, upon which the CSI for the one of the plurality of beams is reported and measurements and evaluation are discontinued, such that measurements are not performed and evaluated for one or more beams in the first predetermined set of beams. As shown at block 920, the method further comprises sending, to the at least one wireless device, a reporting configuration message directing the at least one wireless device to operate in the low-power reporting mode for beam evaluation.

In some embodiments of the method 900, e.g., as implemented by the radio network equipment 1100 shown in FIG. 8, the determination that the low-power mode is to be selectively enabled for the at least one wireless device is based on an evaluation of network load, such that the low-power mode is selectively enabled for relatively low network loads. In other embodiments, the at least one wireless device is a first wireless device, and the determination that the low-power mode is to be selectively enabled for the at least one wireless device and said sending the reporting configuration message are in response to determining that the first wireless device has a need to operate in the low-power mode. In some of these embodiments, determining that the first wireless device has a need to operate in the low-power mode is based on one or more of: a category or type of the first wireless device; and an evaluation of expected traffic frequency and/or size for the first wireless device.

It will be appreciated that in a given network implementation, multiple instances of radio network equipment 1100 will be in use. In some cases, several instances of radio network equipment 1100 at a time may be communicating with or transmitting signals to a given wireless device or group of wireless devices. Thus, it should be understood that while many of the techniques described herein may be carried out by a single instance of radio network equipment 1100, these techniques may be understood as carried out by a system of one or more instances of radio network equipment 1100, in some cases in a coordinated fashion. The radio network equipment 1100 shown in FIG. 8 is thus a simple example of this system.

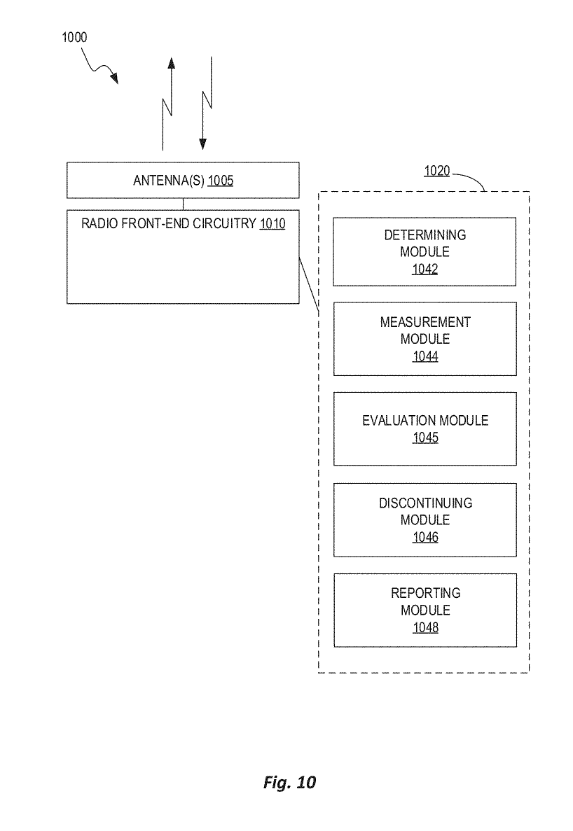

FIG. 10 illustrates an example functional module or circuit architecture as may be implemented in a wireless device 1000, e.g., based on the processing circuitry 1020. The illustrated embodiment at least functionally includes a determining module 1042, for determining a reporting quality threshold for a parameter related to CSI. The embodiment further includes a measurement module 1044 for performing a measurement for each of a plurality of beams from a first predetermined set of beams for evaluation, and an evaluation module 1045 for evaluating the measurement for each of the plurality of beams against the reporting quality threshold. The illustrated embodiment further includes a discontinuing module 1046 for discontinuing the performing and evaluating of measurements in response to determining that the reporting quality threshold is met for one of the beams, such that measurements are not performed and evaluated for one or more beams in the first predetermined set of beams, and a reporting module 1048 for reporting, to the wireless communications network, CSI for the one of the beams.

In some embodiments, the modules of wireless device 1000 described above are configured to carry out the above functions in a first time interval, in a first reporting mode. During a second time interval, in a second reporting mode, these or other modules may be configured to instead perform a measurement for each beam in a second predetermined set of beams for evaluation, identify, based on the measurements, a best beam according to one or more predetermined criteria, and report, to the wireless communications network, CSI for the best beam. Some embodiments may comprise a receiving module for receiving a reporting configuration message from the wireless communication network, the reporting configuration message directing the wireless device to operate in the second reporting mode.

In some embodiments, the determining module 1042 is adapted for determining the reporting quality threshold by receiving the reporting quality threshold or an indication of the reporting quality threshold from the wireless communications network. In others, the determining module 1042 is adapted for determining the reporting quality threshold by calculating the reporting quality threshold based on an expected data rate. In some embodiments, the reporting quality threshold is a path-loss threshold corresponding to estimated path-losses for each of the beams for which measurements are performed, while in others the reporting quality threshold is an SIR threshold or an SINR threshold, corresponding to estimated SIR or SINR for each of the beams for which measurements are performed. In still other embodiments, the reporting quality threshold is a propagation delay threshold, which is compared to an estimated propagation delay for each of one or more of the plurality of beams. In some embodiments, the determining module 1042 is adapted to determine the reporting quality threshold based on a buffer status for the wireless device.

In some embodiments, the discontinuing module 1046 is adapted for discontinuing of the performing and evaluating of measurements further in response to evaluating an availability of a radio channel in a direction of the one of the beams. In some embodiments, this may comprise evaluating the availability of the radio channel in the direction of the one of the beams is based on previous experience with LBT operation in the direction of the one of the beams, or based on previous experience with LBT operation in one or more directions other than the direction of the one of the beams, or both.

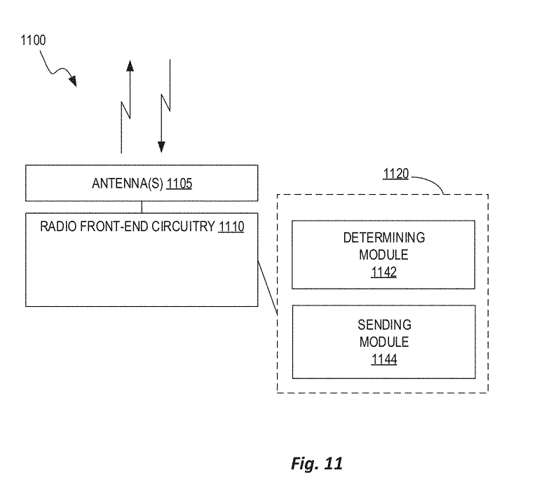

Similarly, FIG. 11 illustrates an example functional module or circuit architecture as may be implemented in a radio network node 1100, e.g., based on the processing circuitry 1120. The illustrated embodiment at least functionally includes a determining module 1142, for determining, for at least one wireless device operating in the wireless network, that a low-power mode for beam evaluation is to be selectively enabled for the at least one wireless device, where the low-power mode for beam evaluation is a beam-evaluation mode in which measurements for each of a plurality of beams in a predetermined set of beams are performed and evaluated until a measurement for one of the plurality of beams. The embodiment further includes a sending module 1144 for sending, to the at least one wireless device, a reporting configuration message directing the at least one wireless device to operate in the low-power reporting mode for beam evaluation.

In some embodiments, determining module 1142 is adapted to determine that the low-power mode is to be selectively enabled for the at least one wireless device based on an evaluation of network load, such that the low-power mode is selectively enabled for relatively low network loads. In some embodiments, the at least one wireless device is a first wireless device, and determining module 1142 is adapted to determine that the low-power mode is to be selectively enabled for the at least one wireless device and to send the reporting configuration message in response to determining that the first wireless device has a need to operate in the low-power mode. In some embodiments, this determining that the first wireless device has a need to operate in the low-power mode is based on one or more of: a category or type of the first wireless device; and an evaluation of expected traffic frequency and/or size for the first wireless device.

1-33. (canceled)

34. A method, in a wireless device, for operating in a wireless communications network, the method comprising:
determining a reporting quality threshold for a parameter related to channel state information (CSI);
performing a measurement for each of a plurality of beams from a first predetermined set of beams for evaluation;
evaluating the measurement for each of the plurality of beams against the reporting quality threshold;
discontinuing the performing and evaluating of measurements in response to determining that the reporting quality threshold is met for one of the beams, such that measurements are not performed and evaluated for one or more beams in the first predetermined set of beams; and
reporting, to the wireless communications network, CSI for the one of the beams.

35. The method of claim 34, wherein the steps of claim 1 are performed during a first time interval, in a first reporting mode, and wherein the method further comprises, during a second time interval, in a second reporting mode:
performing a measurement for each beam in a second predetermined set of beams for evaluation;
identifying, based on the measurements, a best beam according to one or more predetermined criteria; and
reporting, to the wireless communications network, CSI for the best beam.

36. The method of claim 35, wherein the method further comprises receiving a reporting configuration message from the wireless communication network, the reporting configuration message directing the wireless device to operate in the second reporting mode.

37. The method of claim 34, wherein determining the reporting quality threshold comprises receiving the reporting quality threshold or an indication of the reporting quality threshold from the wireless communications network.

38. The method of claim 34, wherein determining the reporting quality threshold comprises calculating the reporting quality threshold based on an expected data rate.

39. The method of claim 34, wherein the reporting quality threshold is a path-loss threshold corresponding to estimated path-losses for each of the beams for which measurements are performed.

40. The method of claim 34, wherein the reporting quality threshold is a signal-to-interference ratio (SIR) threshold or a signal-to-noise-plus-interference (SINR) threshold, corresponding to estimated SIR or SINR for each of the beams for which measurements are performed.

41. The method of claim 34, wherein the reporting quality threshold is a propagation delay threshold, which is compared to an estimated propagation delay for each of one or more of the plurality of beams.

42. The method of claim 34, wherein determining the reporting quality threshold is based on a buffer status for the wireless device.

43. The method of claim 34, wherein the discontinuing of the performing and evaluating of measurements is further in response to evaluating an availability of a radio channel in a direction of the one of the beams.

44. The method of claim 43, wherein evaluating the availability of the radio channel in the direction of the one of the beams is based on previous experience with listen-before-talk (LBT) operation in the direction of the one of the beams, or based on previous experience with LBT operation in one or more directions other than the direction of the one of the beams, or both.

45. A method, in one or more network nodes operating in a wireless communications network, the method comprising:
determining, for at least one wireless device operating in the wireless network, that a low-power mode for beam evaluation is to be selectively enabled for the at least one wireless device, the low-power mode for beam evaluation being a beam-evaluation mode in which measurements for each of a plurality of beams in a predetermined set of beams are performed and evaluated until a measurement for one of the plurality of beams meets a reporting quality threshold for a parameter related to channel state information (CSI), upon which the CSI for the one of the plurality of beams is reported and measurements and evaluation are discontinued, such that measurements are not performed and evaluated for one or more beams in the first predetermined set of beams; and
sending, to the at least one wireless device, a reporting configuration message directing the at least one wireless device to operate in the low-power reporting mode for beam evaluation.

46. The method of claim 45, wherein said determining that the low-power mode is to be selectively enabled for the at least one wireless device is based on an evaluation of network load, such that the low-power mode is selectively enabled for relatively low network loads.

47. The method of claim 45, wherein the at least one wireless device is a first wireless device, and wherein said determining that the low-power mode is to be selectively enabled for the at least one wireless device and said sending the reporting configuration message are in response to determining that the first wireless device has a need to operate in the low-power mode.

48. The method of claim 47, wherein said determining that the first wireless device has a need to operate in the low-power mode is based on one or more of:
a category or type of the first wireless device; and
an evaluation of expected traffic frequency and/or size for the first wireless device.

49. A wireless device, comprising radio-frequency circuitry and processing circuitry operatively connected to the radio-frequency circuitry and configured to:
determine a reporting quality threshold for a parameter related to channel state information (CSI);
perform a measurement for each of a plurality of beams from a first predetermined set of beams for evaluation, using the radio-frequency circuitry;
evaluate the measurement for each of the plurality of beams against the reporting quality threshold;
discontinue performing and evaluating measurements in response to determining that the reporting quality threshold is met for one of the beams, such that measurements are not performed and evaluated for one or more beams in the first predetermined set of beams; and
report CSI for the one of the beams to the wireless communications network, using the radio-frequency circuitry.

50. The wireless device of claim 49, wherein the processing circuitry is configured to carry out the determining, performing, evaluating, discontinuing, and reporting of claim 16 during a first time interval, in a first reporting mode, and wherein wireless device is further configured to, during a second time interval, in a second reporting mode:
perform a measurement for each beam in a second predetermined set of beams for evaluation;
identify, based on the measurements, a best beam according to one or more predetermined criteria; and
report, to the wireless communications network, CSI for the best beam.

51. The wireless device of claim 50, wherein the processing circuitry is further configured to receive a reporting configuration message from the wireless communication network, the reporting configuration message directing the wireless device to operate in the second reporting mode.

52. The wireless device of claim 49, wherein the processing circuitry is configured to determine the reporting quality threshold by receiving the reporting quality threshold or an indication of the reporting quality threshold from the wireless communications network.

53. The wireless device of claim 49, wherein the processing circuitry is configured to determine the reporting quality threshold by calculating the reporting quality threshold based on an expected data rate.

54. The wireless device of claim 49, wherein the reporting quality threshold is a path-loss threshold corresponding to estimated path-losses for each of the beams for which measurements are performed.

55. The wireless device of claim 49, wherein the reporting quality threshold is a signal-to-interference ratio (SIR) threshold or a signal-to-noise-plus-interference (SINR) threshold, corresponding to estimated SIR or SINR for each of the beams for which measurements are performed.

56. The wireless device of claim 49, wherein the reporting quality threshold is a propagation delay threshold, and wherein the processing circuitry is further configured to compare the reporting quality threshold to an estimated propagation delay for each of one or more of the plurality of beams.

57. The wireless device of claim 49, wherein the processing circuitry is configured to determine the reporting quality threshold based on a buffer status for the wireless device.

58. The wireless device of claim 49, wherein the processing circuitry is configured to discontinue the performing and evaluating of measurements further in response to evaluating an availability of a radio channel in a direction of the one of the beams.

59. The wireless device of claim 58, wherein the processing circuitry is configured to evaluate the availability of the radio channel in the direction of the one of the beams based on previous experience with listen-before-talk (LBT) operation in the direction of the one of the beams, or based on previous experience with LBT operation in one or more directions other than the direction of the one of the beams, or both.

60. A system comprising one or more network nodes, each network node comprising a processing circuit and a communications interface circuit operatively coupled to the processing circuit, wherein the one or more network nodes are adapted to:
transmit a first downlink signal comprising an uplink access configuration index, the uplink access configuration index identifying an uplink access configuration from among a plurality of predetermined uplink access configurations, and subsequently receive a transmission from a first wireless device according to the identified uplink access configuration; and
transmit, in a first subframe, a first Orthogonal Frequency-Division Multiplexing (OFDM) transmission formatted according to a first numerology and transmitting, in a second subframe, a second OFDM transmission formatted according to a second numerology, the second numerology differing from the first numerology.

61. The system of claim 60, wherein the one or more network nodes are adapted to determine that the low-power mode is to be selectively enabled for the at least one wireless device based on an evaluation of network load, such that the low-power mode is selectively enabled for relatively low network loads.

62. The system of claim 60, wherein the at least one wireless device is a first wireless device, and wherein the one or more network nodes are adapted to determine that the low-power mode is to be selectively enabled for the at least one wireless device in response to determining that the first wireless device has a need to operate in the low-power mode.

63. The system of claim 62, wherein the one or more network nodes are adapted to determine that the first wireless device has a need to operate in the low-power mode based on one or more of:
a category or type of the first wireless device; and
an evaluation of expected traffic frequency and/or size for the first wireless device.

64. A user equipment, UE, for operating in a wireless communications network, said UE comprising:
one or more antennas configured to send and receive wireless signals;
processing circuitry;
radio front-end circuitry connected to the antenna and to the processing circuitry, and configured to condition signals communicated between the antenna and the processing circuitry;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE;
the processing circuitry being configured to:
determine a reporting quality threshold for a parameter related to channel state information (CSI);
perform a measurement for each of a plurality of beams from a first predetermined set of beams for evaluation;
evaluate the measurement for each of the plurality of beams against the reporting quality threshold;
discontinue performing and evaluating measurements in response to determining that the reporting quality threshold is met for one of the beams, such that measurements are not performed and evaluated for one or more beams in the first predetermined set of beams; and
report, to the wireless communications network, CSI for the one of the beams.
